(19) United States
(12) Patent Application Publication
(10) Pub. No.: US 2022/0104337 A1
(43) Pub. Date: Mar. 31, 2022

(54) ELECTRODE FOR PLASMA A GUN

(71) Applicant: OERLIKON METCO (US) INC., Westbury, NY (US)

(72) Inventors: Junya KITAMURA, Kanagawa (JP); Ronald J. MOLZ, Farmingville, NY (US); Toshiyuki YAMANE, Tokyo (JP)

(73) Assignee: OERLIKON METCO (US) INC., Westbury, NY (US)

(21) Appl. No.: 17/298,406

(22) PCT Filed: Nov. 27, 2019
(86) PCT No.: PCT/US2019/063495

§ 371 Date: May 28, 2021

Related U.S. Application Data
(60) Provisional application No. 62/773,776, filed on Nov. 30, 2018.

(51) Int. Cl. H05H 1/48

(52) U.S. Cl. CPC H05H 1/48; H05H 2242/10

(57) ABSTRACT

A cathode for a plasma gun includes a main body having a first end and a second end, wherein the first end has a protrusion. A method of using the cathode includes mounting the cathode inside a plasma gun and generating an arc discharge via the protrusion.

### CROSS-REFERENCE TO RELATED APPLICATIONS

The instant application is a U.S. National Stage of PCT/US2019/063495 filed Nov. 27, 2019 and claims priority under 35 U.S.C. § 119(e) of U.S. provisional Patent Application No. 62/773,776 filed on Nov. 30, 2018. The disclosures of which are expressly incorporated by reference herein in their entireties.

### STATEMENT REGARDING SPONSORED RESEARCH OR DEVELOPMENT

Not Applicable.

### BACKGROUND OF THE INVENTION

### Field of the Invention

Plasma spray applications that involve spraying small parts or parts that cannot be subjected to high heat input pose issues with most plasma guns. Spaying small parts results in low target efficiency (TE) as most of the sprayed material or sprayed powder misses the small targeted part. These small parts are often sensitive to heat input and can be damaged by the total amount of power needed to heat and/or accelerate the material or powder to be deposited.

### Discussion of Background Information

The use of smaller power levels and/or smaller guns often results in poor treatment of material or powder and lower deposition efficiency (DE) as the energy density to process the material or power is reduced or lowered. Additionally, the use of small plasma nozzle bores to create small plasma plumes results in plume velocities that are too high for proper treatment and deposition of the material or powder as well.

FIGS. 1-9 show one non-limiting example of a prior art plasma gun 100 (only the certain main portions of the gun are shown for purposes of illustration) that has an interchangeable and replaceable cathode 110. As can be readily seen, the cathode 110 is mechanically and electrically connected to a main portion 150 of the plasma gun 100 via an interface. A seal 160 is axially spaced from this interface.

As can be seen in FIG. 5, the cathode 110 has a mounting portion 120 and a tip 130 from whose front end 132 a plasma arc discharges in a continuous manner during plasma spraying. The tip 130 has a rear portion 131 that is fixed to and extends into a receiving zone 124 of the mounting portion 120. The mounting portion 120 includes a main internal space 121 which is sized and configured to receive therein cooling fluid and accommodates therein a front portion of a cooling tube 140. Cooling fluid passes through the tube 140 via a main cooling passage 170 of the plasma gun 100. The mounting portion 120 also includes an external thread 122 which threads into comparable internal threads 151 of the component 150 and functions to axially mechanically fix and electrically connect the cathode 110 to a main internal component 150 of the plasma gun 100. To provide sealing between the cathode 110 and the component 150 to among other things, prevent cooling fluid (typically pressurized) from escaping from the space 121, a seal or O-ring 160 at a location other than an area of an annular connecting interface formed between the interface coupling surface 123 of the cathode 110 and the interface coupling surface 152 of the internal component 150. The O-ring 160 is spaced from the interface 123/152 and is arranged in a generally circumferential groove 125. The groove 125 can be arranged on the cathode 110 as an outer circumferential groove. As a result of the configuration shown, a standardized interface is provided between the components 110 and 150.

Referring now to FIGS. 6-9, it can be seen that the prior art cathode 110 has a generally cylindrical mounting portion 120 and a generally cylindrical tip 130 from whose front end 132 a plasma arc discharges in a continuous manner during plasma spraying. The mounting portion 120 includes a generally cylindrical main internal space 121 which is sized and configured to receive therein cooling fluid and accommodates therein a front portion of a cooling tube 140 (see FIG. 5). The mounting portion 120 also includes an external thread 122 arranged on a rear end of the portion 120 as well as hex-shaped portion arranged adjacent the tip 130. The hex-shaped portion is sized and configured so that an operator can remove the cathode 110 using a suitable tool such as a wrench or socket wrench, and, in this way, unthread the external threads 122 from the internal threads 151 of the internal component 150 during cathode 110 removal. The same hex-shaped portion allows an operator to install the cathode 110 using a suitable tool such as a wrench or socket wrench, and, in this way, thread the external threads 122 into the internal threads of the internal component 150 during cathode 110 installation. A groove 125 can be arranged on the cathode 110 as an outer circumferential groove and this groove 125 is axially spaced from an interface coupling surface 123 of the cathode 110.

Plasma guns used for thermal spray have cathodes that have a rounded, flat, or inclined shape (see FIGS. 17-19) designed to produce a wide thermionic emission zone to allow the plasma gun to operate with as much power as physically possible without serious damage or melting to the cathode.

A plasma gun such as C+Plasma Model 3A is also known and this model utilizes a copper cathode with a tungsten tip that generates a relatively narrow emission zone. However, this gun typically operates with much higher power levels such as up to 120 kW and uses a significantly larger emission zone that is desired, e.g., 4 mm in diameter and 2 mm long.

What is needed in the art is a way to produce a plasma plume of sufficient energy density but at a lower total power level without adversely affecting the resulting particle/material/powder temperature or velocity.

### SUMMARY OF THE INVENTION

Non-limiting embodiments of the invention include an electrode for a plasma gun, comprising a main body having a first end and a second end, wherein the first end has a protrusion. The protrusion may be a projection or extension and may have a reduced diameter or reduced-cross-section tip or portion arranged to form a forwardmost portion of the electrode. The diameter of the reduced diameter portion is typically less that 3 or 4 mm and shorter than 2 mm in length or projection so as to form an emission zone that is significantly less than 4 mm in diameter.

Non-limiting embodiments of the invention include a cathode for a plasma gun, comprising an elongated body having a first end and a second end, wherein the first end has a protrusion.

In embodiments, the first end is made of a first material and the second end is made of a second material.

In embodiments, the first and second ends are made of different materials.

In embodiments, the protrusion projects from a flat surface.

In embodiments, the protrusion projects from a conical surface.

In embodiments, the protrusion projects from a dome shaped surface.

In embodiments, the protrusion is between about 0.5 mm and about 2.0 mm in diameter and projects at least 0.5 mm from a surface and/or no more that 2 or 3 times a diameter of the protrusion.

In embodiments, the first material is at least one of tungsten or doped tungsten.

In embodiments, the first end of the cathode is an emission end.

In embodiments, the second material is copper.

In embodiments, the cathode is water cooled.

In embodiments, the protrusion is coaxially aligned with a center acts of the elongated body.

Non-limiting embodiments of the invention include a method of using the cathode or electrode described above, comprising mounting the cathode inside a plasma gun and generating an arc discharge via the protrusion.

In embodiments, the protrusion limits a size of an emission zone.

In embodiments, the protrusion increases current density in an emission zone.

Non-limiting embodiments of the invention include an electrode for use in a plasma gun comprising a main body having a first end and a second end, wherein the first end has an arc discharge protrusion.

Non-limiting embodiments of the invention include a cathode for a plasma gun, comprising a main or elongated body having a first end and a second end and a protrusion projecting from an end surface of the first end.

In embodiments, the protrusion has a base diameter of between about 0.5 mm and about 2 mm and projects from the end surface by at least about 0.5 mm and/or no more that 2 or 3 times a diameter of the protrusion.

In embodiments, the first and second ends are made of different materials.

In embodiments, the protrusion projects from a flat end surface.

In embodiments, the protrusion projects from a conical end surface.

In embodiments, the protrusion projects from a dome shaped end surface.

In embodiments, there is also provided an electrode for use in a plasma gun comprising a main body having an emission end and a mounting end, wherein the emission end has an arc discharge extension of reduced diameter or cross-section that forms a forwardmost portion of the main body.

In embodiments, there is also provided a cathode for a plasma gun, comprising a metal body having an arc discharge end and amounting end and a reduced-diameter portion projecting or extending from an end surface of the arc discharging end.

In embodiments, the reduced-diameter or reduced cross-section portion is between about 0.5 mm and about 2.0 mm in diameter and projects at least 0.5 mm from a surface and/or no more that 2 or 3 times a diameter of the protrusion.

In embodiments, there is also provided a cathode for a plasma gun, comprising a metal body having an arc discharge end and a mounting end and a reduced-diameter portion tapered or pointed projecting or extending from an end surface of the arc discharging end.

In embodiments, there is also provided a cathode for a plasma gun, comprising a metal body having an arc discharge end and a mounting end and a reduced-diameter semi-spherical or bulbous portion projecting or extending from an end surface of the arc discharging end.

In embodiments, there is also provided a cathode for a plasma gun, comprising a metal body having an arc discharge end and a mounting end and a reduced-diameter stepped-shaped portion projecting or extending from an end surface of the arc discharging end.

In embodiments, there is also provided a cathode for a plasma gun, comprising a metal body having an arc discharge end and a mounting end and a reduced-diameter ring-shaped portion projecting or extending from an end surface of the arc discharging end.

By altering the cathode or electrode shape to have a protrusion or sharp tip, the resulting plasma plume can be made more concentrated and this in turn produces a more confined spray profile suitable for spraying small targets using less total power and retaining the necessary energy density to process the powder and/or coating on the target.

According to another aspect, the invention relates to an electrode for use in a plasma gun comprising a tungsten body having a first end and a second end, wherein the first end has a centrally located arc discharge extension of reduced diameter or cross-section.

According to another aspect, the invention relates to an electrode for use in a plasma gun comprising a tungsten body having a first end and a second end, wherein the first end has an arc discharge extension of reduced diameter or cross-section and forming a forwardmost portion of the main body.

According to another aspect, the invention relates to a cathode for a plasma gun, comprising a tungsten body having a first end and a second end; and a reduced-diameter tungsten portion projecting or extending from an end surface of the first end.

In an embodiment of the cathode, the protrusion has a base diameter of between about 0.5 mm and about 2 mm and projects from the end surface by at least about 0.5 mm; and no more that 2 or 3 times a diameter of the protrusion.

In an embodiment of the cathode, the first and second ends are arranged on a one-piece integrally formed member.

In an embodiment of the cathode, the reduced-diameter portion projects from a flat end surface of the first end.

In an embodiment of the cathode, the reduced-diameter portion projects from a conical end surface of the first end.

In an embodiment of the cathode, the reduced-diameter portion projects from a dome shaped end surface of the first end.

According to another aspect, the invention relates to an electrode for use in a plasma gun comprising a tungsten main body having an emission end and a mounting end, wherein the emission end has an arc discharge extension of reduced diameter or cross-section that forms a forwardmost portion of the main body.

According to another aspect, the invention relates to a cathode for a plasma gun, comprising a tungsten body having an arc discharge end and a mounting end; and a reduced-diameter portion projecting or extending from an end surface of the arc discharging end.

In an embodiment of the cathode, the reduced-diameter or reduced cross-section portion is between about 0.5 mm and about 2.0 mm in diameter and projects at least 0.5 mm from a surface and/or no more that 2 or 3 times a diameter of the reduced-diameter or reduced cross-section portion.

According to another aspect, the invention relates to a cathode for a plasma gun, comprising a tungsten body having an arc discharge end and a mounting end; and a reduced-diameter portion tapered or pointed projecting or extending from a larger diameter end surface of the arc discharging end.

In an embodiment of the cathode, the reduced-diameter portion is between about 0.5 mm and about 2.0 mm in diameter and projects at least 0.5 mm from a surface and/or no more that 2 or 3 times a diameter of the reduced-diameter portion.

According to another aspect, the invention relates to a cathode for a plasma gun, comprising a tungsten body having an arc discharge end and a mounting end; and a reduced-diameter semi-spherical or bulbous portion projecting or extending from an end surface of the arc discharging end.

In an embodiment of the cathode, the reduced-diameter portion is between about 0.5 mm and about 2.0 mm in diameter and projects at least 0.5 mm from a surface and/or no more that 2 or 3 times a diameter of the reduced-diameter portion.

According to another aspect, the invention relates to a cathode for a plasma gun, comprising a tungsten body having an arc discharge end and a mounting end; and a reduced-diameter stepped-shaped portion projecting or extending from an end surface of the arc discharging end.

In an embodiment of the cathode, the reduced-diameter portion is between about 0.5 mm and about 2.0 mm in diameter and projects at least 0.5 mm from a surface and/or no more that 2 or 3 times a diameter of the reduced-diameter portion.

According to another aspect, the invention relates to a cathode for a plasma gun, comprising a tungsten body having an arc discharge end and a threaded mounting end; and a reduced-diameter ring-shaped portion projecting or extending from an end surface of the arc discharging end.

In an embodiment of the cathode, the reduced-diameter portion is between about 0.5 mm and about 2.0 mm in diameter and projects at least 0.5 mm from a surface and/or no more that 2 or 3 times a diameter of the reduced-diameter portion.

According to another aspect, the invention relates to a cathode for a plasma gun, comprising a tungsten body comprising at least one generally cylindrical section; an arc discharge end; a mounting end; and a single, axially-oriented and centrally disposed, reduced-diameter portion projecting or extending from an end surface of the arc discharging end.

In an embodiment of the cathode, the reduced-diameter portion is between about 0.5 mm and about 2.0 mm in diameter and projects at least 0.5 mm from a surface and/or no more that 2 or 3 times a diameter of the reduced-diameter portion.

According to another aspect, the invention relates to a cathode for a plasma gun, comprising a one-piece metal body comprising at least one generally cylindrical section; an arc discharge end; a mounting end; and a single, axially-oriented and centrally disposed, reduced-diameter portion that is a forwardmost portion of the arc discharging end.

In an embodiment of the cathode, the reduced-diameter portion is between about 0.5 mm and about 2.0 mm in diameter and projects at least 0.5 mm from a surface and/or no more that 2 or 3 times a diameter of the reduced-diameter portion.

### BRIEF DESCRIPTION OF THE DRAWINGS

Non-limiting embodiments of the invention can be seen from the drawings wherein:

FIGS. 1 and 2 show front and back views of a prior art plasma gun which can be modified to utilize a cathode of the type described herein;

FIG. 3 shows a cross-section of the plasma gun shown in FIGS. 1 and 2;

FIG. 4 shows a cross-section of an internal portion of the plasma gun shown in FIG. 3;

FIG. 5 shows a cross-section of an internal portion of the portion shown in FIG. 4;

FIGS. 6-9 show various views of a prior art cathode used in the plasma gun of FIGS. 1 and 2;

FIG. 10 shows a partial view of a cathode in accordance with one embodiment of the invention which can be used in place of the cathode shown in FIGS. 6-9;

FIG. 10A shows a front view of the cathode of FIG. 10;

FIG. 10B shows an enlarged side view of the cathode of FIG. 10;

FIG. 11 shows a cross-section of the cathode of FIG. 10;

FIG. 12 shows a partial cross-section view of a cathode in accordance with another embodiment of the invention which can be used in place of the cathode shown in FIGS. 6-9;

FIG. 13 shows a partial cross-section view of a cathode in accordance with another embodiment of the invention which can be used in place of the cathode shown in FIGS. 6-9;

FIG. 14 shows a partial cross-section view of a cathode in accordance with another embodiment of the invention which can be used in place of the cathode shown in FIGS. 6-9;

FIG. 14A shows an enlarged side view of the cathode of FIG. 14;

FIG. 15 shows a partial cross-section view of a cathode in accordance with another embodiment of the invention which can be used in place of the cathode shown in FIGS. 6-9;

FIG. 15A shows an enlarged side view of the cathode of FIG. 15;

FIG. 16 shows a partial cross-section view of a cathode in accordance with another embodiment of the invention which can be used in place of the cathode shown in FIGS. 6-9;

FIG. 16A shows an enlarged side view of the cathode of FIG. 16;

FIGS. 17-19 show partial cross-section views of three prior art cathodes;

FIG. 20 illustrates three profiles of the shaped deposit produced by spraying onto a flat plate; and

FIGS. 21 and 22 shows TDE on steel rod and DE on flat plate to illustrate a comparison between an invented electrode and a standard (prior art) electrode.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Furthermore, in the following description, the various embodiments of the present disclosure will be described with respect to the enclosed drawings. As required, detailed embodiments of the embodiments of the present disclosure are discussed herein; however, it is to be understood that the disclosed embodiments are merely exemplary of the embodiments of the disclosure that may be embodied in various and alternative forms. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ the present disclosure.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, such that the description, taken with the drawings, making apparent to those skilled in the art how the forms of the present disclosure may be embodied in practice.

As used herein, the singular forms “a,” “an,” and “the” include the plural reference unless the context clearly dictates otherwise. For example, reference to “a spray device” would not preclude the use of plural or multiple spray devices unless specifically excluded. For example, as used herein, the indefinite article “a” indicates one as well as more than one and does not necessarily limit its referent noun to the singular.

Except where otherwise indicated, all numbers expressing quantities used in the specification and claims are to be understood as being modified in all instances by the term “about.” For example, a range of 1 to 5 is intended to encompass or be equivalent to a range of about 1 to about 5. Accordingly, unless indicated to the contrary, the numerical parameters set forth in the specification and claims are approximations that may vary depending upon the desired properties sought to be obtained by embodiments of the present disclosure. At the very least, and not to be considered as an attempt to limit the application of the doctrine of equivalents to the scope of the claims, each numerical parameter should be construed in light of the number of significant digits and ordinary rounding conventions.

As used herein, the terms “about” and “approximately” indicate that the amount or value in question may be the specific value designated or some other value in its neighborhood. Generally, the terms “about” and “approximately” denoting a certain value is intended to denote a range within ±5% of the value. As one example, the phrase “about 100” denotes a range of 100±5, i.e. the range from 95 to 105. Generally, when the terms “about” and “approximately” are used, it can be expected that similar results or effects according to the disclosure can be obtained within a range of ±5% of the indicated value.

Additionally, the recitation of numerical ranges within this specification is considered to be a disclosure of all numerical values and ranges within that range (unless otherwise explicitly indicated). For example, if a range is from about 1 to about 50, it is deemed to include, for example, 1, 7, 34, 46.1, 23.7, or any other value or range within the range.

As used herein, the term “and/or” indicates that either all or only one of the elements of said group may be present. For example, “A and/or B” shall mean “only A, or only B, or both A and B”. In the case of “only A”, the term also covers the possibility that B is absent, i.e. “only A, but not B”.

Terms such as “substantially parallel” can refer to deviating less than 20° from parallel alignment and the term “substantially perpendicular” refers to deviating less than 20° from perpendicular alignment. The term “parallel” refers to deviating less than 5° from mathematically exact parallel alignment. Similarly “perpendicular” refers to deviating less than 5° from mathematically exact perpendicular alignment.

The term “at least partially” is intended to denote that the following property is fulfilled to a certain extent or completely.

The terms “substantially” and “essentially” are used to denote that the following feature, property or parameter is either completely (entirely) realized or satisfied or to a major degree that does not adversely affect the intended result.

The term “comprising” as used herein is intended to be non-exclusive and open-ended. Thus, for instance a composition comprising a compound A may include other compounds besides A. However, the term “comprising” also covers the more restrictive meanings of “consisting essentially of” and “consisting of”, so that for instance “a composition comprising a compound A” may also (essentially) consist of the compound A.

The various embodiments disclosed herein can be used separately and in various combinations unless specifically stated to the contrary.

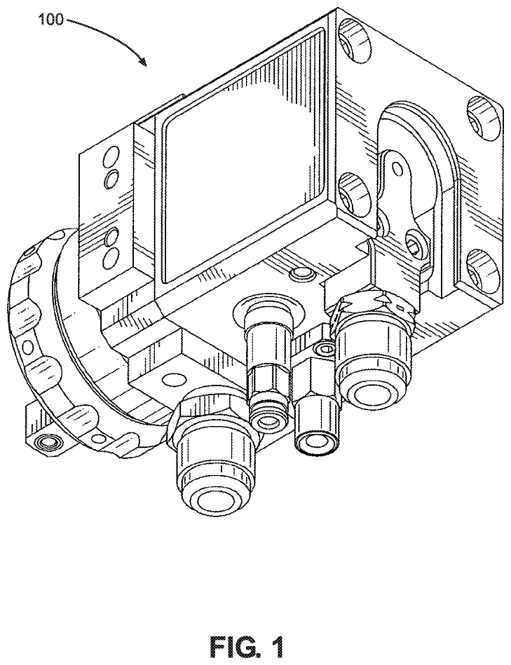

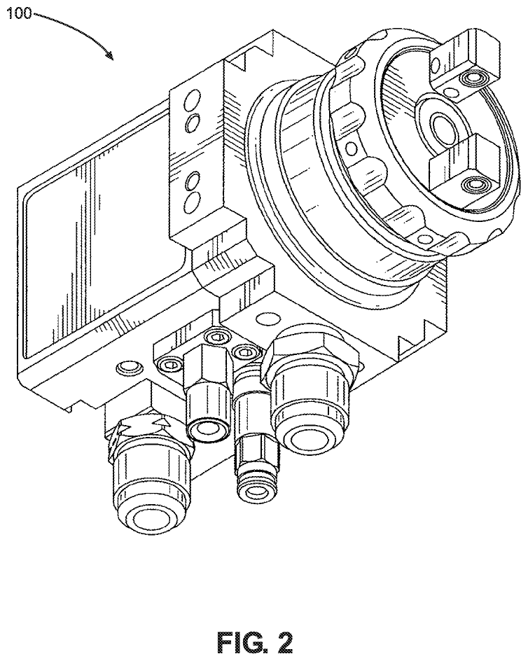

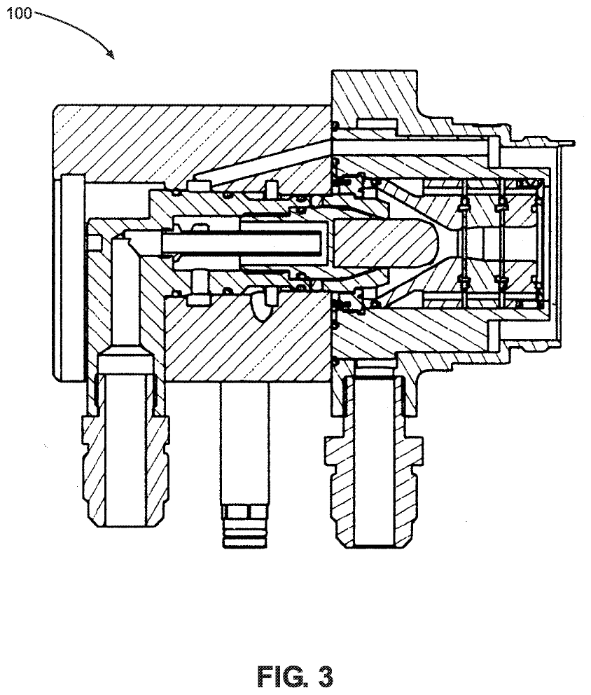

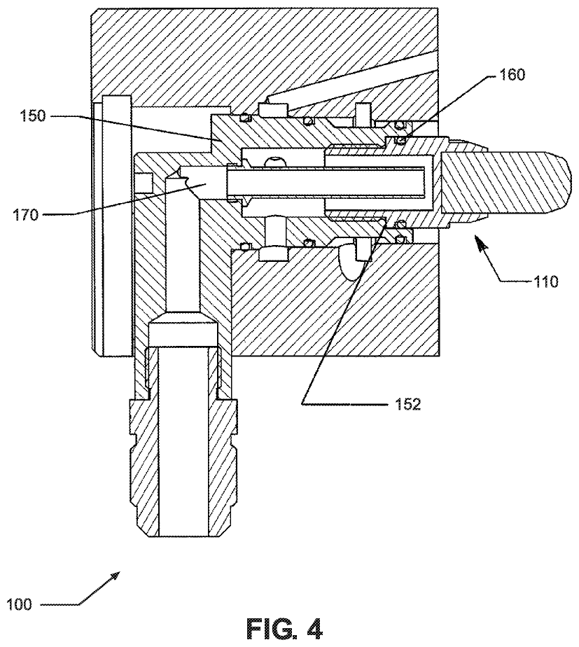

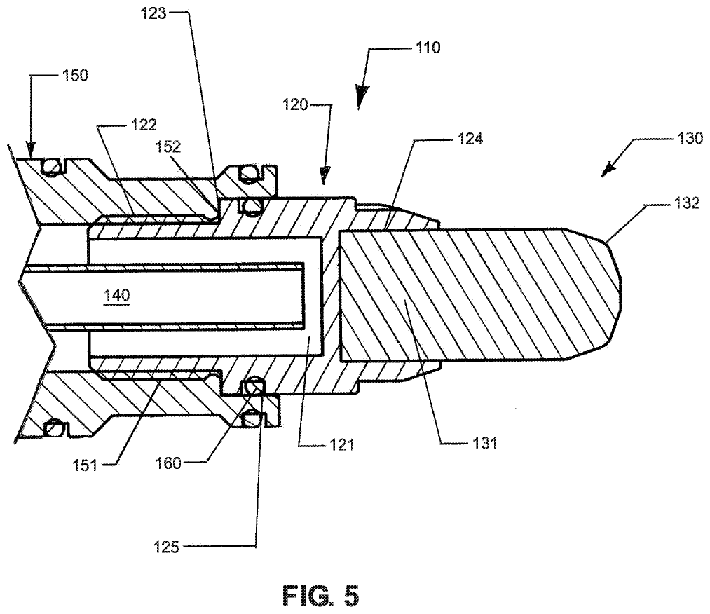

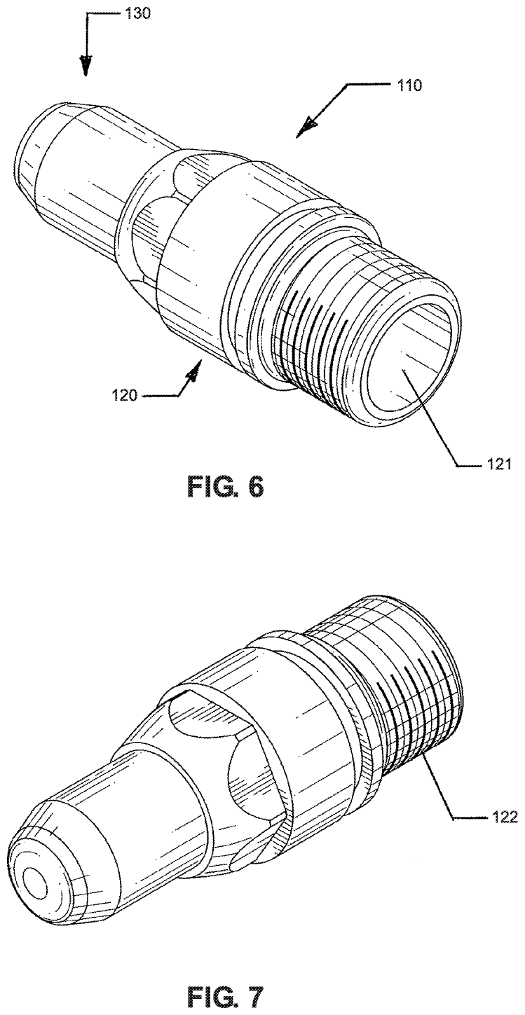

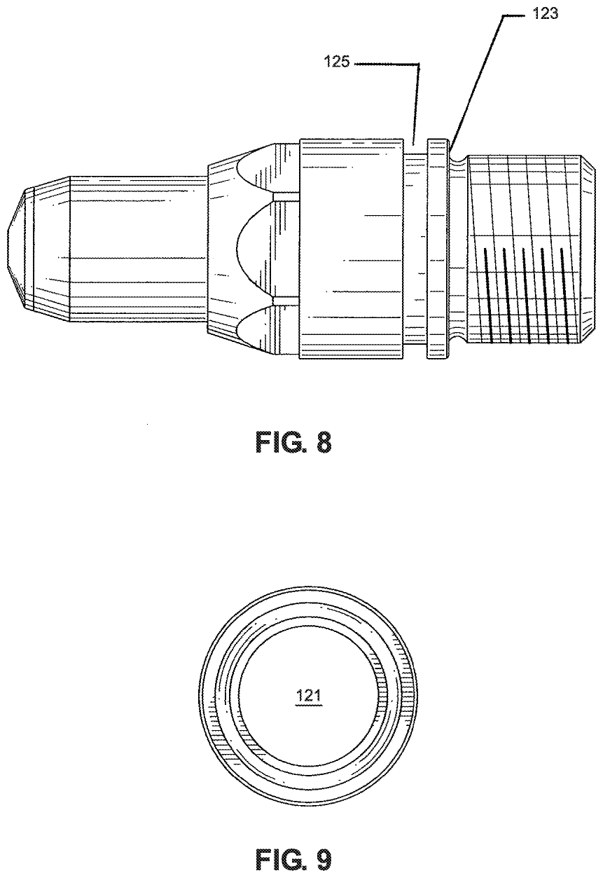

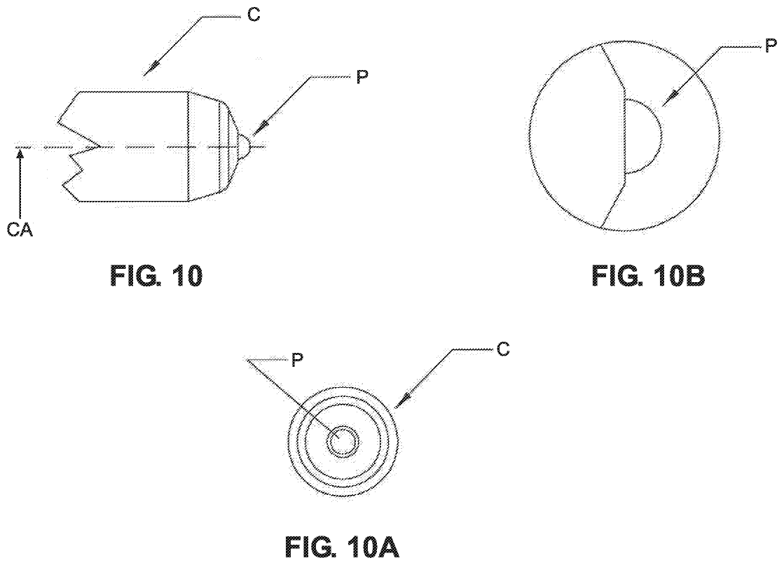

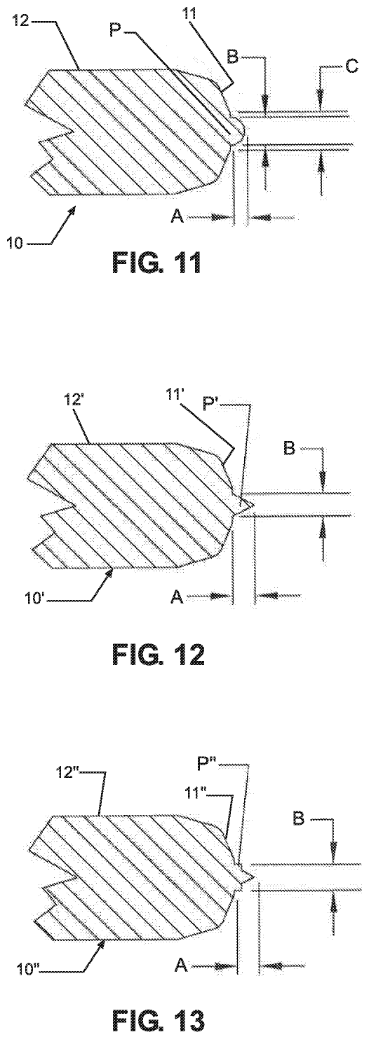

The electrode 10 in accordance with non-limiting aspects of the invention can be used, by way of non-limiting example, to replace the electrode 110 shown in FIGS. 1-9. As can be seen in the example of FIGS. 10, 10A, 10B and 11, the cathode C or electrode 10 includes a protrusion P located on an emission end 11 of a main or elongated body 12 which has one or more generally cylindrical sections. The protrusion P is a projection or extension and has a reduced diameter or reduced-cross-section and forms a tip or portion that constitutes a forwardmost portion of the electrode. The protrusion P can be either integrally formed with the body of the cathode C or a separately formed member mounted thereto. The protrusion P can be centered on the emission zone and/or cathode axis CA and serves to restrict the emission zone to a size or area smaller than would normally be produced by an equivalent cathode without the protrusion. For example, the smaller emission zone can be about 50% smaller in area than one generated by a cathode in a typical plasma gun such as that shown in FIGS. 1-9. The power level used for such a smaller emission zone can be about 28 kW whereas the power level used in the Simplex Pro 90 plasma gun of FIG. 1 is about 42 kW when used to spray a similar coating material.

In the example shown in FIGS. 10 and 11, the protrusion P has rounded shape and projects from a flat circular ridge having a diameter C of about 3.2 mm. The projection P has a baser diameter B of between about 0.5 mm and about 2 mm and projects a distance A of at least about 0.5 mm. The projection P is sized and configured to create a charge concentration that restricts the emission zone size or area and forms a tighter, more current dense, plasma arc which, in turn, results in a narrower plasma plume with higher energy density.

Other embodiments are shown in FIGS. 12-16 and in these embodiments the height or length of projection of the protrusion P can range from about 0.2 mm to about 2.0 mm. The bottom or base diameter B of the protrusion can range from about 0.5 mm to about 2.0 mm, whereas the diameter of the main body 12 of the electrode 10 can range from about 5 to about 19 mm. The ratio of height/bottom diameter of the protrusion can range from about 0.5 to about 2.0.

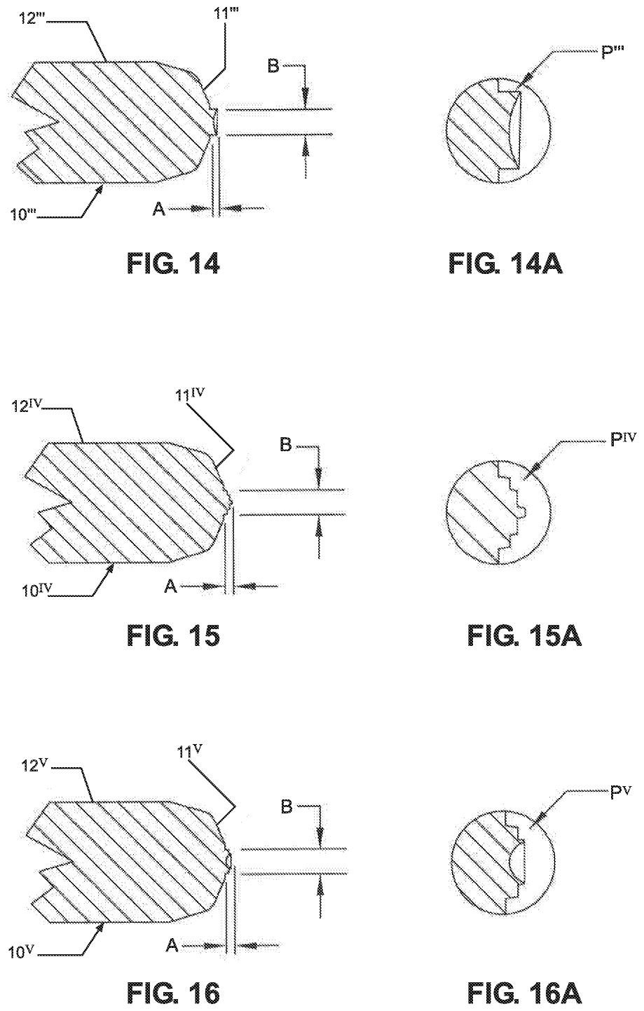

Exemplary embodiments or shapes of the protrusion P can include mountain shaped protrusions as in the case of FIG. 12, stepped protrusions as in the case of FIGS. 13, 15 and 16, and ringed protrusions as in the case of FIGS. 14 and 16. Other protrusion shapes or combinations thereof may also be used. Still further, the protrusion will generally be centered on the central axis of the main electrode body and may vary from center between about 0 mm and 1 mm with a range of about 0 to about 0.5 mm being most desirable.

Thus, in the embodiment of FIG. 12, the cathode 10′ has a main body 12′, an emission end 11′ and a pointed or mountain shaped projection P′.

In the embodiment of FIG. 13, the cathode 10″ has an elongage body 12″, an emission end 11″ and a pointed and stepped shaped projection P″.

In the embodiment of FIG. 14, the cathode 10′″ has an elongage body 12′″, an emission end 11′″ and a ringed recess shaped projection P′″.

In the embodiment of FIG. 15, the cathode 10^{IV} has an elongage body 12^{IV}, an emission end 11^{IV} and a pointed and stepped shaped projection P^{IV}.

In the embodiment of FIG. 16, the cathode 10^{V} has an elongage body 12^{V}, an emission end 11^{V} and a pointed and stepped shaped projection P^{V}.

The operating power of the plasma using an exemplary electrode of the invention can be less than 40 kW, and can preferably be less than 35 kW and more preferably is less than 30 kW for a plasma gun having a normal power limit of 80 kW. In general, the power can be limited to less than 50% of the maximum gun power level for a specific gun, preferably less than 44%, and most preferably less than 38%. The power should be at least about 7.5% of the maximum power or the lowest operating power where the plasma gun can maintain a plasma arc, whichever is less.

The plasma gun hardware life, most specifically the cathode, can be affected with the affect either to increase hardware life due to lower power operation or decrease hardware life due to increase in plasma arc density. Results will vary depending upon the specific application and parameter sets.

### Example

A cathode C or 10 of the type shown in FIGS. 10 and 11 can be used in a Oerlikon Metco Sinplex-Pro plasma gun (replacing cathode 110 or tip 130 in FIGS. 1-9) and can have a projection P with a bulbous shaped protrusion (such as shown in FIGS. 10 and 11) that is about 0.75 mm in diameter at the base B and about 0.35 mm in height A. A non-limiting power level that can be used such an electrode can be about 28 kW and this example can utilize an emission zone that is about 25% the area which would be generated by the cathode used in the embodiment of FIGS. 1-9.

In another example or modification of the Examiner above, the plasma gun using the inventive cathode can be operated at about 300 amps and about 92.5 volts for a power level of about 27.8 kW which is significantly lower than a one with a prior art cathode operating at 450 amps and 94 volts and utilizing a power level of about 42.3 kW.

Tests have been conducted using a test setup to spray and measure both Deposit Efficiency (DE) on flat plate and Target Deposition Efficiency (TDE) on a 5 mm steel bar representing a small diameter part. Weight gain per unit time on the flat plate was used to determine DE while the profile of powder sprayed onto the plate was also used to determine the width of the spray pattern. In a similar fashion, the weight gain on the steel bar was used to determine the TDE. Such tests have successfully demonstrated the operation of one or more embodiments of the invention.

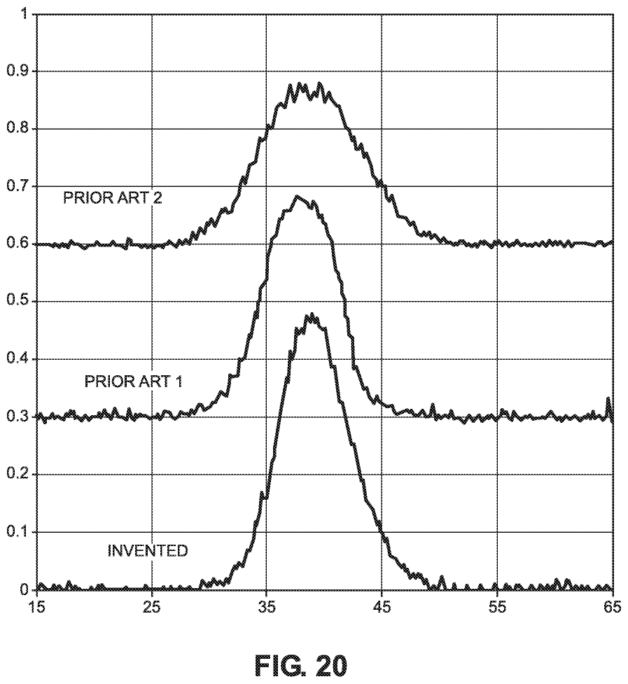

FIG. 20 shows spray profiles of alumina deposited on a flat plate. The X-axis represents distance in millimeters (mm) spanning the profile cross-section and the Y-axis represents height of the spray deposit. The example labeled “Prior art 1” represents a spray coating applied using an Oerlikon Metco Sinplex Pro plasma gun equipped with a standard electrode. “Prior art 2” was used to spray a coating using an Oerlikon Metco 9 MB gun equipped with a standard electrode. Profile titled “Invented” was used to spray a coating using an Oerlikon Metco Sinplex Pro plasma gun with the cathode depicted in FIGS. 10 and 11. The “Invented” cathode also produced the smallest spray pattern in relative width and the most concentrated in relative height of spray spot. Assuming a target width of a 5 mm steel bar representing a part to be sprayed, it can readily be seen the TDE is significantly higher when using the invented cathode.

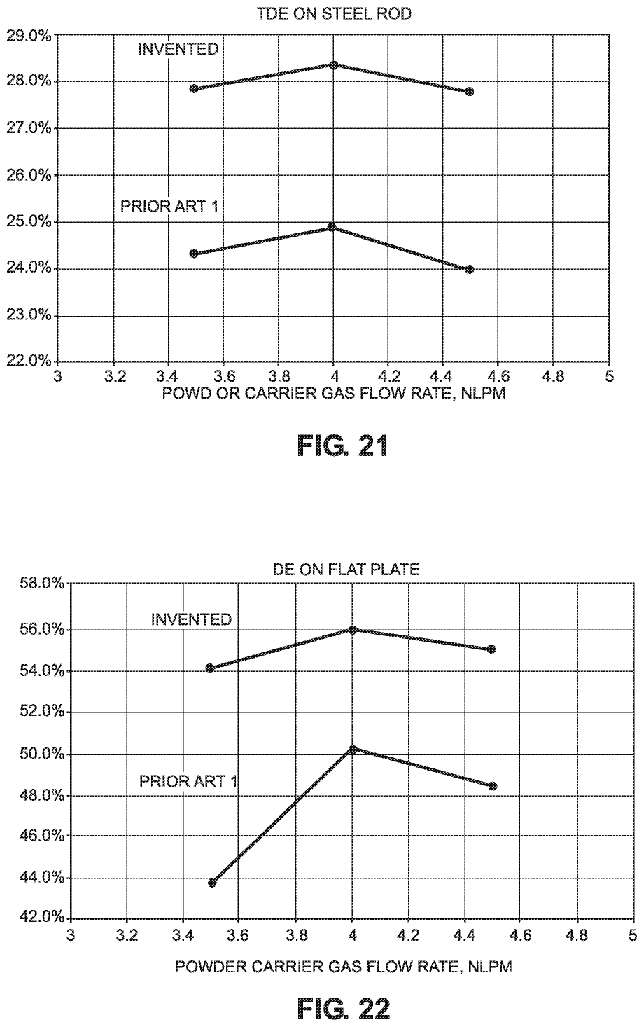

FIGS. 21 and 22 show the resulting measured TDE (top graph) on a steel rod and the resulting measured DE (bottom graph) on a flat plate for the prior art 1 and the invented cathode using an Oerlikon Metco Sinplex Pro plasma gun operated at 28 kW. As should be apparent, there is a significant increase for both values when the plasma gun is equipped with the cathode of the invention. Carrier gas flow was changed to show optimal deposition for both spray conditions.

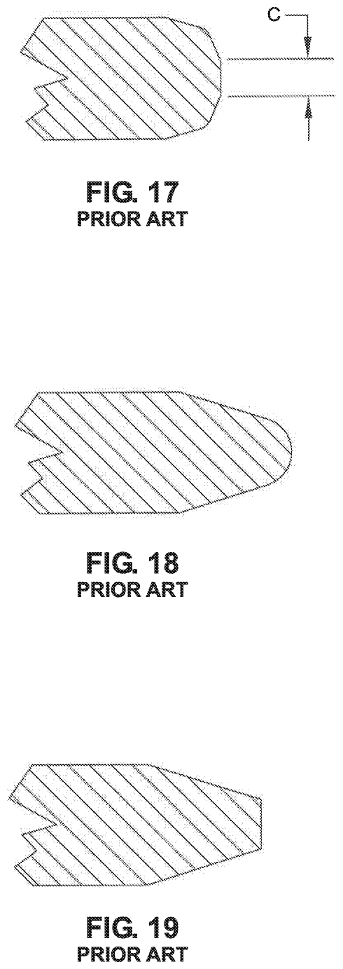

Other embodiments include adding or forming any one of the protrusions illustrated in FIGS. 10-16 to any one of the prior art cathodes shown in FIGS. 17-19. Such cathodes have a generally cylindrical main body and either short (FIG. 17) or longer tapered ends (FIGS. 18 and 19). Such modification can include removing the cathode from the plasma gun, performing metal removing or machining on the cathode in order to shape the foremost end so as to have a single centrally disposed and axially oriented protrusion of the type shown or described herein, reinstalling the cathode on the plasma gun. One can then operate the plasma gun with significantly reduced power during the application of a coating material.

One skilled in the art can discern other ways to measure both DE and TDE as well as TE by itself using different mechanisms currently available in the industry. In addition, those skilled in the art can conceive similar protrusions shapes and combinations thereof within the scope of this invention.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A cathode for a plasma gun, comprising:
a main body having a first end and a second end; and
a protrusion extending from the first end,
wherein the protrusion has an emission zone diameter that is less than about 4 mm.

2. The cathode of claim 1, wherein the protrusion is one of a reduced diameter or reduced cross-section projection, is a forwardmost portion of the main body and has an axial length less than about 2 mm.

3. The cathode of claim 1, wherein the protrusion has at least one of a smaller diameter or smaller cross-section than any other portion of the main body.

4. The cathode of claim 1, wherein the first end is a first material and the second end is a second material.

5. The cathode of claim 1, wherein the first and second ends are different materials.

6. The cathode of claim 1, wherein the protrusion projects from a flat surface of the first end.

7. The cathode of claim 1, wherein the protrusion projects from a conical surface of the first end.

8. The cathode of claim 1, wherein the protrusion projects from a dome shaped surface of the first end.

9. The cathode of claim 1, wherein the protrusion is between about 0.5 mm and about 2.0 mm in diameter and projects at least 0.5 mm and less than about 2 mm from a surrounding surface of the first end.

10. The cathode of claim 2, wherein the first material is tungsten or doped tungsten.

11. The cathode of claim 1, wherein the first end of the cathode is an emission end.

12. The cathode of claim 4, wherein the second material is copper.

13. The cathode of claim 1, wherein the cathode is water cooled.

14. The cathode of claim 1, wherein the protrusion is coaxially aligned with a center axis of the main body.

15. A method of using the cathode of claim 1, comprising:
mounting the cathode inside a plasma gun; and
generating an arc discharge via the protrusion.

16. A method of using the cathode of claim 1, wherein the protrusion limits a size of an emission zone or spray area.

17. A method of using the cathode of claim 1, wherein the protrusion increases current density in an emission zone.

18.-40. (canceled)

41. A method of modifying a cathode of a plasma gun, comprising:
removing the cathode from the plasma gun;
performing metal removing or machining on the cathode in order to shape the forwardmost or arc discharging end so as to have a single centrally disposed and axially oriented protrusion; and
reinstalling the cathode on the plasma gun.

42. The method of claim 41, further comprising operating the plasma gun with a power during the application of a coating material, said power being a lower power compared to a power used in operating the plasma gun before the cathode is modified.
